(19) United States
(12) Patent Application Publication
(10) Pub. No.: US 2005/0031753 A1
(43) Pub. Date: Feb. 10, 2005

(54) Reduced fat absorption in prepared foods

(76) Inventors: Jennifer A. Gaul, Cummings, KS (US); Christopher T. Dohl, Netawaka, KS (US); Gregory J. Stempien, Atchison, KS (US); Clodualdo C. Maningat, Platte City, MO (US); Sukh D. Bassi, Atchison, KS (US)

Correspondence Address: LATHROP & GAGE LC, 2345 GRAND AVENUE, SUITE 2800, KANSAS CITY, MO, 64108, US

(21) Appl. No.: 10/637,455

(22) Filed: Aug. 8, 2003

(51) Int. Cl. A21D 10/00

(52) U.S. Cl. 426/549

(57) ABSTRACT

The present invention is directed to compositions and methods of using same for reducing the absorption of fat in the preparation of food products by employing a wheat protein isolate.

### FIELD OF THE INVENTION

The present invention relates to compositions and methods for reducing the absorption of fat in the preparation of fried food products. Specifically, the composition and method of using same involves making a prepared fried food product having reduced fat content by employing a wheat protein isolate.

### BACKGROUND OF THE INVENTION

Consumer interest in weight control and healthy eating is driving food processors to increase their offerings of foods having reduced fat contents and high nutritional value. Numerous medical studies have shown a link between a high fat dietary intake and disease, including diabetes and heart disease. Health groups have recommended that fat consumption in the human diet be reduced, so that no more than 30% of caloric energy is derived from fat. Unfortunately, the fat contained in food products provides much of the desirable eating qualities, such as taste, mouthfeel, aroma, and texture.

A significant proportion of the nutritional intake of an average adult is made up of fried foods, which can be very high in fat, as the food tends to absorb the frying fat medium during the frying process. Nonetheless, consumers continue to demand fried food products. The food industry has therefore continually searched for methods of producing fried foods that are both comparable in taste and quality to regular fried foods, but also lower in fat and calories.

Processes have been developed to generate fried foods having a lower fat content. Some processes seek to form a film or coating on the raw foodstuff or dough to provide a barrier to the uptake of the frying fat medium. Other processes reduce the fat content of fried foods by including a food additive in a dough or batter that reduces the fat content of the fried food product.

U.S. Pat. No. 6,001,399 discloses the use of polydextrose as a replacement for sugar as a fat absorption inhibitor in fried foods, thus resulting in fried foods having a reduced fat content.

U.S. Pat. No. 4,810,660 discloses a process for producing potato patties having less oil content. In the disclosed process, potato shreds are combined with a dry binder that includes retrograded amylose. During frying, the amylose forms a continuous film around the periphery of the patty reducing oil absorption during frying.

U.S. Pat. No. 4,937,086 discloses a process for preparing donuts having reduced fat, which involves employing polyvinylpyrrolidone in the batter.

Another example of a technique used to minimize the uptake of frying fats during deep frying is disclosed in U.S. Pat. No. 5,232,721, where an improved deep frying method is employed where foods are coated with an edible polymer, such as a protein, modified protein, carbohydrate or modified carbohydrate, in order to form a continuous coating that functions as a barrier to minimize the uptake of the frying fats.

U.S. Pat. No. 5,217,736 discloses a similar process wherein foodstuffs are coated with a continuous protein oil barrier film cast from an aqueous latex suspension of water and soluble hydrophobic protein microspheres. This film is suitable as an oil barrier to reduce oil absorption into the foods.

U.S. Pat. No. 5,569,483 discloses cellulose derivatives incorporated into gelled starch food products having a high water content, such as a batter, which is cooked by immersion in hot fat, which provides a product having a crisp outer surface and a lower uptake of the cooking fat.

U.S. Pat. No. 5,464,642 discloses a process of making reduced fat fried snacks with more expanded, lighter structures than that of conventional dough-based fried snacks. These reduced fat fried snacks are produced from a sheetable dough which contains calcium carbonate, starch-based flour, hydrolyzed starches, emulsifiers and water.

Studies aimed at reducing the fat content of specific fried food products, such as fried cake donuts, have also been reported. It is known that fat absorption accounts for 15% to 25% of the finished weight of a fried donut.

Because of the concerns of health groups and health conscious consumers regarding the high fat content in fried donuts, various methods for reducing the fat content of fried donuts have been investigated. It has been reported that certain reformulated cake donut batters inhibit the absorption of the frying fat medium during frying.

A study entitled “Reduced Fat Uptake and Increased Moisture Retention in Yeast-leavened Donuts with Methylcellulose and HPMC” reported by D. A. Bell and L. W. Steinke at the Poster Session, American Association of Cereal Chemists (AACC) Annual Meeting, Minneapolis, Minn. 1995, experiments were conducted using donut batters containing 1% powdered hydroxypropylmethylcellulose (HPMC). The fat content of the finished fried donut formed from the batter having HPMC was reported to be significantly less than the finished fried donut formed from a control batter. Oil reductions of 27% were also achieved in fried donuts containing HPMC and methylcellulose.

A second study entitled “Effects of Protein from Different Sources on the Characteristics of Sponge Cakes, Rice Cakes, Doughnuts and Frying Batters” reported in the Journal of the Science of Food and Agriculture 68(3) 271-277 1995, soy flour was added to cake donut formulas to reduce fat absorption during frying. The donuts containing soy flour had reduced oil absorption compared to the control donuts.

In spite of the documented efforts to produce a fried food, such as a cake donut, having a lower fat content, there still exists a continuing need to provide additional methods for making reduced fat preapared foods that have the flavor attributes and physical properties of conventional fried food products.

Thus, it would be a valuable contribution to the art to provide a composition for use in prepared foods and methods for using same which provides a finished food product having reduced fat content.

### SUMMARY OF THE INVENTION

The present invention relates to a composition having a wheat protein isolate and method of using same for reducing the absorption of fat in the preparation of food products.

The invention further relates to a composition having a wheat protein isolate and method of using same for making a fried food product having a reduced fat content.

The invention still further relates to a food product having a wheat protein isolate which inhibits the absorption of fat when the product is prepared.

The invention additionally relates to a dough or batter having a wheat protein isolate which inhibits the absorption of fat when the product is prepared.

The invention yet still further relates to a food product having a wheat protein isolate which inhibits the absorption of fat when the product is fried.

The invention yet additionally relates to a dough or batter having a wheat protein isolate which inhibits the absorption of fat when the product is fried.

The invention also relates to methods of preparing a food product having a wheat protein isolate wherein said prepared food product has reduced fat content.

### BRIEF DESCRIPTION OF THE DRAWINGS

FIG. 1 illustrates the percent fat present in products containing non-fat dry milk versus Arise 5000™.

FIG. 2 illustrates the percent estimated fat absorption in products containing non-fat dry milk versus Arise 5000™.

FIG. 3 illustrates the percent fat present in food products containing various combinations of non-fat dry milk and Arise 5000™.

### DETAILED DESCRIPTION OF THE INVENTION

Wheat protein isolates have been found to reduce the absorption of fats during food preparation. The addition of the wheat protein isolate to the food product does not adversely affect the conventional handling of the food product during preparation, and provides a food product with an extended shelf life. These wheat protein isolates may be added to a number of fresh or frozen food products to generate reduced calorie foods, such as breads, cake batters, donut batters, cookie batters, pastries, food coatings, and the like. Food coatings containing the wheat protein isolates would include coatings that would be applied to food prior to addition of the food item to cooking oil, such as coatings for fried potato products, and the like. Suitable batters which would employ the wheat protein isolates would include batters for use in the preparation of cake donuts.

Wheat protein isolates are found in Arise TM ingredients, such as Arise 5000™ [wheat protein isolate (wheat gluten, lactic acid, sulfite)] which make bakery products that taste fresher and last longer, and are produced more efficiently.

Arise 5000™ is employed in frozen and refrigerated dough systems. The wheat protein isolates possess film-forming capabilities, which controls water migration during the freeze-thaw or cooking process, and increases freshness and extends shelf life in finished goods. Prepared in a water solution, Arise 5000™ can produce a film coating that can be applied to products, such as pizza crusts, to serve as a moisture and fat barrier, as well as to enhance the crispness.

As employed in the present invention, the Arise 5000™ wheat protein isolates may be present in the food product in the range of from about 0.5 wt % to about 10.0 wt % by flour weight, and more preferably in an amount ranging from about 1.5 wt % to about 3.0 wt % by flour weight. Preferred for the practice of the present invention is 1.5 to 3.0 wt % Arise 5000™ per total flour weight.

In the preparation of the food product containing the wheat protein isolate of the present invention, the food product would come in direct contact with oil. The cooking process would thereby employ frying or baking. Preferred for the practice of the present invention is frying as the cooking process.

In preparing the fried food product having a reduced fat content the process typically includes the steps of forming a dough or batter by combining the various ingredients including a wheat protein isolate such as Arise 5000™, and frying the dough or batter. The use of a wheat protein isolate in combination with the other ingredients in accordance with the present invention provides fried food products having a reduced fat content. Frying the dough or batter in a frying fat medium, with the addition of a wheat protein isolate reduces the adsorption of the frying fat medium into the fried food product, whereby a reduced fat content fried food product is obtained.

The present invention further provides a dough or batter composition useful in making fried food products which comprises various ingredients, including an amount of a wheat protein isolate effective to reduce the adsorption of the frying fat medium into the fried food product.

Suitable fats or oils to be employed in the cooking process, wherein said cooking process is either baking or frying, include vegetable oils or animal fat-based oils. Preferred for the practice of the present invention is a vegetable oil. Particularly preferred is a hydrogenated vegetable oil.

Food products which may be prepared having a reduced fat content are not limited to those listed herein.

### EXAMPLES

Experiments were conducted to evaluate the effectiveness of using a wheat protein isolate such as Arise 5000™ in reducing fat absorption in prepared foods. Specifically, various studies were performed to evaluate the addition of Arise 5000™ wheat protein isolate for its effectiveness in reducing fat absorption in fried cake donuts.

### Example 1

### Chocolate Cake Doughnut Processing

Procedure

Dry Mix

Step # 1

Cream crystalline fructose, ultra fine pure cane sugar and dextrose (Set #1) with emulsifier for 5 minutes at speed 2 in a Kitchen Aid mixer using the wire wisk attachment. Liquid vanilla and soy bean oil (Set #2) were then slowly incorporated with the sugar/emulsifier mixture and mixed for 10 minutes at speed 2 in a 5 qt. Kitchen Aid mixer (wisk attachment). The sides and bottom of the mixing bowl were continually scraped during the mixing.

Step #2

Add pre-weighed and blended ingredients (Set #3) to the sugar mixture (Step #1) and mix at speed 2 for 10 minutes (5 qt. Kitchen Aid mixer, paddle attachment). Occasionally scrape sides and bottom of the bowl during the 10-minute mix.

Step #3

Add flour mixture (Set #4) to Step #2 and mix for 10 minutes at speed 2.

Batter Development

Step #4

A final batter temperature of 76° F. was achieved with a room temperature of 70° F., mixing temperature at 71° F. with a friction of 3° F. and water added at 89° F. The water was added slowly to the dry mix and mixed with a paddle attachment using a 5 qt. Kitchen Aid mixer (or 12 qt. Hobart depending on batch size). After all the water was added the batter was mixed for 30 seconds at speed 1. The sides of the bowl and the paddle were scraped and mixing restarted for another 30 seconds at speed 1. The batter was then mixed at speed 2 for 85 seconds, where half way through the time the bowl and the paddle were scraped. The mixed batter was covered with loose plastic and left to rest for six minutes in the same bowl.

Frying:

Step #5

Daylight Donut fat frying grease was used to deep-fry the doughnuts in a 24″×24″ Belshaw tabletop doughnut fryer. With the fat dept reaching one inch below the top of the fryer. The doughnut depositor used was one inch above the grease line. The doughnuts were fried at 375° F. for 60 seconds on the first side and 60 seconds on the second side. The doughnuts were extracted from the grease and drained for approximately 20 to 30 seconds. The doughnuts were then glazed and left to cool unless further testing was done were no glaze was applied. After achieving a cooled state the doughnuts were then placed in a window doughnut box or testing was conducted.

Doughnut Analysis

Doughnut Observations During Frying

During frying the doughnut's rise time was observed and recorded. The appearance of the surface of the doughnut was also observed during each fry.

Estimated % Fat Absorption

To obtain approximate fat absorption three to four deposited doughnuts were weighed and their weights recorded. After the doughnuts were fried and cooled (approx. 1 hour) their final weights were weighed and recorded (six doughnuts). The approximate fat absorption was determined using the averaged initial and final weights.

Fat Analysis by Acid Hydrolysis

MGP Ingredients uses an outside analytical laboratory (Medallion Laboratory, Minneapolis, Minn.) to determine the total fat content of the doughnuts, which is determined by Acid Hydrolysis. The same analytical laboratory also determines the moisture content of the doughnuts.

Doughnut Diameter

The diameters of six doughnuts from each trial were measured. The measurements were obtained by slicing each doughnut in half horizontally using an electric slicer and measuring the diameter with a ruler to the closest tenth of a centimeter.

Doughnut Firmness

To determine doughnut firmness a Texture Analyzer (TA-XT2I, Scarsdale, N.Y.) was used. AIB Standard Procedure for Bagels was recommended to use for doughnut firmness with modifications by a consultant from the Texture Analyzer Company. Each doughnut was sliced horizontally and the tops used for measurement. Four tests were preformed on each slice. Six slices were tested for each trial, resulting in 24 peaks per trial.

| | | |
|---|---|---|
| TA.XT2 Settings: | Mode: | Measure in force in compression |
| | Option: | Return to Start |
| | Pre-Test Speed: | 2.0 mm/second |
| | Test Speed: | 1.7 mm/second |
| | Post-test Speed: | 10.0 mm/second |
| | Distance: | 6.2 mm |
| | Trigger Type: | Auto |
| | Force: | 10 g |
| | Acquisition: | 200 pps |
| Accessory: | TA-Ball Probe | |

Results:

Each time a measurement was taken, the maximum peak force value was recorded and the average and standard deviation were calculated.

Visual Observation and Organoleptic Properties

The external crust appearance and internal core and cell structure were observed and recorded. A control group of food scientists at MOP Ingredients taste the doughnuts and the organoleptic properties (flavor, color, gumminess etc.) were noted.

Cake donuts were prepared according to the general procedure in Example 1 and ingredients in Table 1.

TABLE 1

| | | |
|---|---|---|
| INGREDIENT | Supplier | TRUE % |

Set #1

| | | |
|---|---|---|
| Sugar: Ultrafine pure cane sugar | United Sugars | 23.18 |
| Crystalline Fructose | Krystar | 4.00 |
| Dextrose 333 | Dawn Food Products | 0.30 |
| Arroplus Emulsifier | Arroplus | 0.29 |

Set #2

| | | |
|---|---|---|
| Vegetable Oil | Generic | 4.38 |
| Pure Vanilla Extract | Dawn Food Products | 0.34 |

Set #3

| | | |
|---|---|---|
| Defatted Soy Flour | Central Soya | 2.00 |
| Corn Flour | Con Agra | 1.50 |
| NFDM-high heat | Dawn Food Products | 2.75 |
| Dried Egg Yolk | Wakefield | 2.00 |
| Salt | Morton | 0.90 |
| Pregel 46 | MGP Ingredients | 0.50 |
| Pregel 10 | MGP Ingredients | 0.50 |
| Centro bake powdered lecithin | Central Soya | 0.25 |
| Baking Soda | Arm and Hammer | 0.74 |
| SAPP #28 | Rhodia | 0.40 |
| SAPP #37 | Rhodia | 0.91 |
| CMC (carboxymethyl cellulose) | TIC Gums | 0.05 |
| Sodium Propionate | American Ingredients | 0.48 |
| Dutched Cocoa | Gittard | 7.85 |

Set #4

| | | |
|---|---|---|
| Flour(25:75, hard to soft) | General Mills | 46.68 |
| TOTAL: | | 100.00 |

Set #1

| | | |
|---|---|---|
| Sugar: Ultrafine pure cane sugar | United Sugars | 23.18 |
| Crystalline Fructose | Krystar | 4.00 |
| Dextrose 333 | Dawn Food Products | 0.30 |
| Arroplus Emulsifier | Arroplus | 0.29 |

Set #2

| | | |
|---|---|---|
| Vegetable Oil | Generic | 4.38 |
| Pure Vanilla Extract | Dawn Food Products | 0.34 |

Set #3

| | | |
|---|---|---|
| Defatted Soy Flour | Central Soya | 2.00 |
| Corn Flour | Con Agra | 1.50 |
| Arise 5000 | MGP Ingredients | 2.75 |
| Dried Egg Yolk | Wakefield | 2.00 |
| Salt | Morton | 0.90 |
| Pregel 46 | MGP Ingredients | 0.50 |
| Pregel 10 | MGP Ingredients | 0.50 |
| Centro bake powdered lecithin | Central Soya | 0.25 |
| Baking Soda | Arm and Hammer | 0.74 |
| SAPP #28 | Rhodia | 0.40 |
| SAPP #37 | Rhodia | 0.91 |
| CMC | TIC Gums | 0.05 |
| Sodium Propionate | American Ingredients | 0.48 |
| Dutched Cocoa | Gittard | 7.85 |

Set #4

| | | |
|---|---|---|
| Flour(25:75, hard to soft) | General Mills | 46.68 |
| TOTAL: | | 100.00 |

The various trials/sets performed and the percentage of Arise 5000™ used in the mixture were as follows:

Set 1. Control: NFDM 2.75%
Set 2. Arise 5000 ™ 1%
Set 3. Arise 5000 ™ 1.5%
Set 4. Arise 5000 ™ 2% Contains 0% NFDM
Set 5. Arise 5000 ™ 2.75%
Set 6. Arise 5000 ™ 3%
Set 7. NFDM .92% and Arise 5000 ™ 1.83%

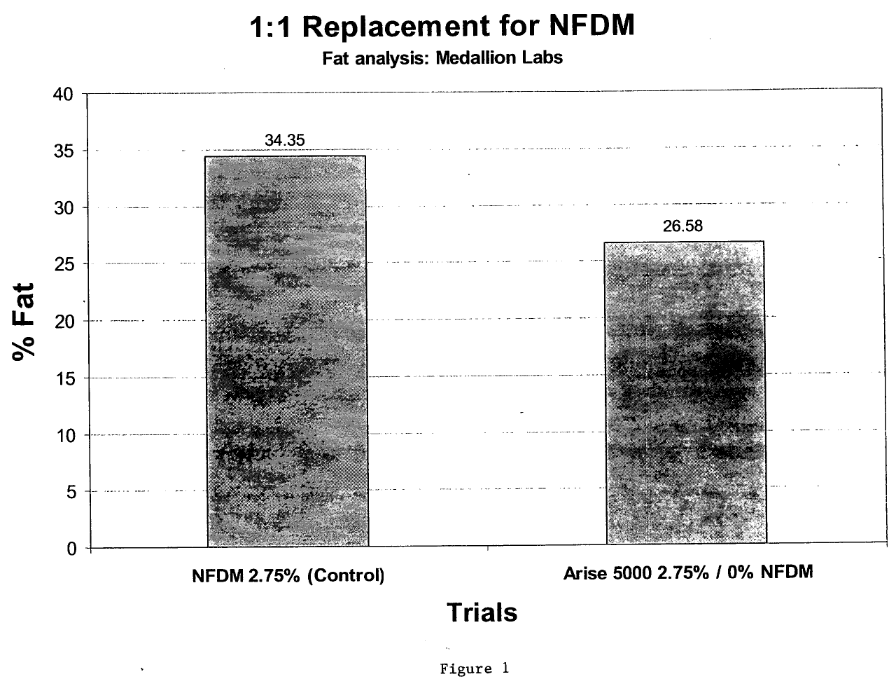

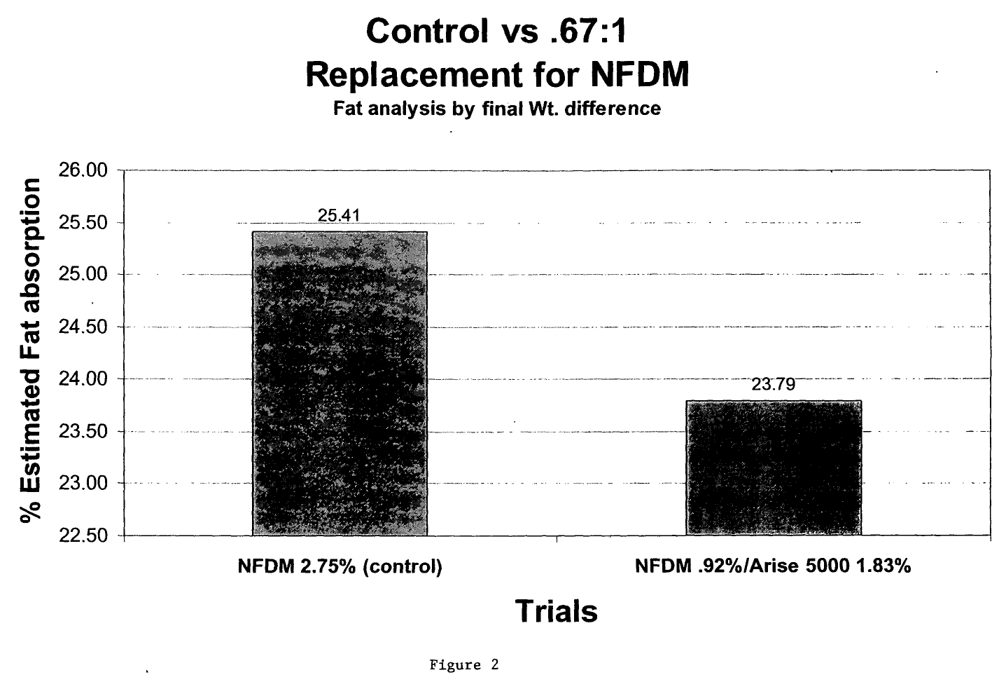

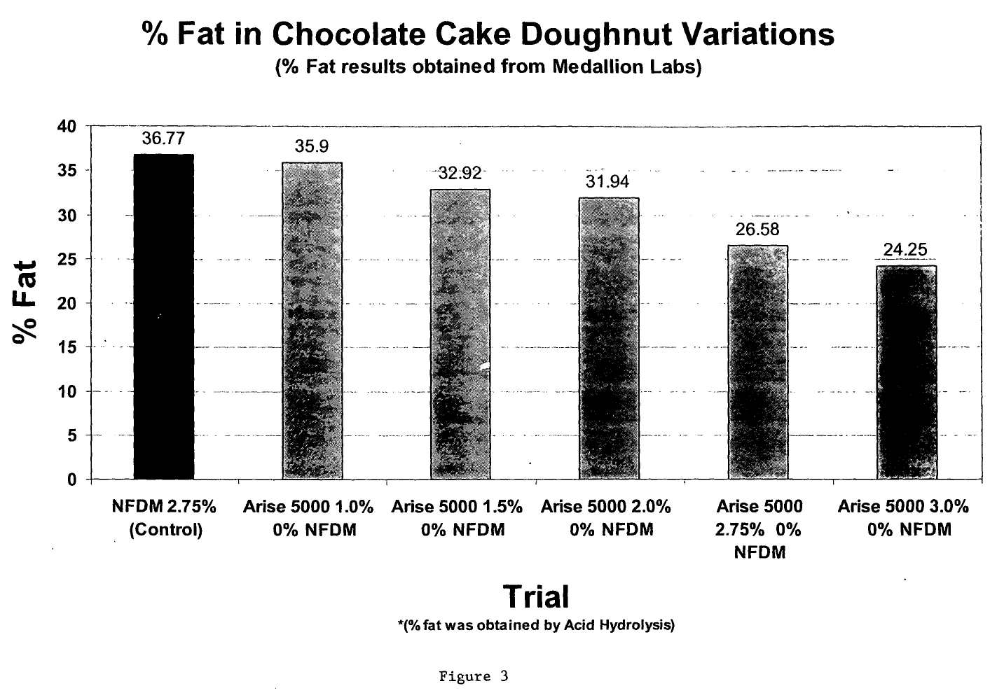

Example 2 and the data provided in FIGS. 1, 2, and 3 show that a wheat protein isolate such as that found in Arise 5000™ can inhibit the fat absorption of fried foods without a significant decrease in product quality.

The following results were deduced from the fat analysis of the various prepared food products:
1. Wheat protein isolate (Arise 5000™) decreases the amount of fat absorption by 8% at a level of 2.75% addition of Arise 5000 replacing 2.75% of NFDM. Fat content analyzed by Medallion Labs in duplicate.
2. The percent of Arise 5000™ and the percent of fat absorption are inversely proportionate to each other. As the percent Arise 5000™ increases the percent fat decreases. (In complete replacement of NFDM).
3. When NFDM was completely replaced with Arise 5000™ (at 2.75%) the percent moisture increased by 3.2%. Moisture content analyzed by Medallion Labs (analysis performed in duplicate).
4. Using the Texture Analyzer the degree of firmness of the chocolate cake doughnut crumb has a trend of being slightly increased. The addition of a protein in combination with exclusion of NFDM contributes to the increased firmness of the doughnut.
5. The average diameter of the chocolate cake doughnuts tended to be slightly smaller than the control (NFDM 2.75%). The decrease in diameter is more than likely due to protein absorbing more water and not allowing as much spread during frying. This can be resolved some by increasing the % water added to the mix.
6. By optimizing the percent water in the doughnut batter without NFDM doughnut size and cell structure are similar to the control doughnut. The optimum water content is 48% for a chocolate cake doughnut with 2.75% Arise 5000.

The Medallion Laboratory method employed in the analysis was the AOAC Official Methods of Analysis number 996.06.

### REFERENCES

Effects of Protein from Different Sources on the Characteristics of Sponge Cakes, Rice Cakes (Apam), Doughnuts and Frying Batters, Suhaila Mohamed, Siti Mawar Md Lajis and Norbashimah Abdul Hamid, “Journal of the Science of Food and Agriculture”, 68(3). 1995. 271-277.
Reduced Fat Uptake and Increased Moisture Retention in Yeast-Leavened Doughnuts with Methylcellulose and Hydroxypropyl Methylcellulose. D. A. Bell and L. W. Steinke, Jun. 19, 1992, The Dow Chemical Company.

1. A composition for use in preparing a food product having reduced fat content which comprises a wheat protein isolate.

2. The composition of claim 1 wherein the wheat protein isolate is present in the range of about 0.5 wt % to about 10.0 wt %.

3. The composition of claim 1 wherein said food product is a fried food product.

4. The composition of claim 3 wherein said fried food product is a cake donut.

5. A composition for use in preparing a fried food product having reduced fat content which comprises a wheat protein isolate.

6. The composition of claim 5 wherein the wheat protein isolate is present in the range of about 0.5 wt % to about 10.0 wt %.

7. The composition of claim 5 wherein said fried food product is a cake donut.

8. A food product having reduced fat content which comprises a wheat protein isolate.

9. The food product of claim 8 wherein the wheat protein isolate is present in the range of about 0.5 wt % to about 10.0 wt %.

10. The food product of claim 8 wherein said food product is a fried food product

11. The food product of claim 10 wherein said fried food product is a cake donut.

12. The food product of claim 8 which is a dough or batter.

13. A method for preparing a food product having a reduced fat content which comprises:
adding a wheat protein isolate to the food product;
cooking said food product by contacting the food product with oil or fat.

14. The method of claim 13 wherein the wheat protein isolate is present in the range of about 0.5 wt % to about 10.0 wt %.

15. The method of claim 13 wherein said food product is fried.

16. The method of claim 13 wherein said food product is baked.
